(19) United States
(12) Patent Application Publication
(10) Pub. No.: US 2011/0170811 A1
(43) Pub. Date: Jul. 14, 2011

(54) SYSTEM AND METHOD FOR CONTROLLING INTERACTION BETWEEN SURFACES

(75) Inventor: H. Brooks Herndon, Lawrence, KS (US)

(73) Assignee: HERNDON DEVELOPMENT LLC, Lawrence, KS (US)

(21) Appl. No.: 13/000,307

(22) PCT Filed: Jun. 19, 2009
(86) PCT No.: PCT/US2009/048019

§ 371 Date: Mar. 23, 2011

Related U.S. Application Data
(60) Provisional application No. 61/074,310, filed on Jun. 20, 2008.

(51) Int. Cl. F16C 29/02; B32B 3/10

(52) U.S. Cl. 384/26; 428/141

(57) ABSTRACT

A system and method for reducing interaction between surfaces (10,12) moving relative to each other. The system includes a first surface (10) having a first number of repetitive surface-asperities (14), e.g., 11, per unit length of surface, and a second surface (12) having a second number of repetitive surface asperities (16), e.g., 13, per unit length of surface, with the first and second numbers being in relative prime ratio, i.e., having no common divisor other than 1. The ratio of repetitive surface asperities may be controlled as a function of component particle size, grain size; groove size; or relative angular orientation of the surfaces (110,112).

### RELATED APPLICATIONS

The present U.S. non-provisional patent application claims priority of a previously filed and co-pending U.S. provisional patent application having the same title, Ser. No. 61/074,310, filed Jun. 20, 2008. The identified previously filed application is hereby incorporated by reference into the present application.

### FIELD OF THE INVENTION

The present invention relates to systems and methods for controlling interaction between surfaces. More specifically, the present invention concerns a system and method for controlling interaction, i.e., interpenetration, between first and second surfaces by arranging or designing the surfaces such that the repetitive surface geometries, or “asperities,” of the surfaces are in particular relative ratios.

### BACKGROUND OF INVENTION

When interacting surfaces move relative to each other, friction between the surfaces converts kinetic energy to heat and can abrade one or both of the surfaces. In some applications, it is desirable to minimize such interactions.

The coefficient of friction is a dimensionless scalar vector describing the ratio of the force of friction between two surfaces and the force bringing them together. A lower coefficient of friction corresponds to less interaction between the surfaces. Coefficients of friction must be measured experimentally as they cannot be calculated.

Interaction between surfaces is often controlled by selecting materials which result in the desired coefficient of friction. However, in many applications, specific materials must be used, and therefore friction cannot be controlled by using different materials. Interaction between surfaces is also often controlled by interposing a lubricating or abrading substance between the surfaces. However, in some applications these additional substances cannot be used, because, for example, they create an unacceptable risk of contamination, and in other applications the substances do not remain consistently interposed between the surfaces.

### SUMMARY OF THE INVENTION

The present invention overcomes the above-described and other problems and disadvantages by providing a system and method for reducing interaction between surfaces moving relative to each other.

In one embodiment, the system broadly comprises a first surface having a first number of repetitive surface asperities per unit length of surface; and a second surface having a second number of repetitive surface asperities per unit length of surface, wherein the first and second numbers are in relative prime ratio, i.e., have no common divisor other than 1, and wherein the first and second surfaces move relative to each other. In one exemplary implementation, the first number is approximately 11 and the second number is approximately 13.

In one embodiment, the method broadly comprises the steps of providing the first surface with a first number of repetitive surface asperities per unit length of surface; and providing the second surface with a second number of repetitive surface asperities per unit length of surface, wherein the first and second numbers are in relative prime ratio. In one implementation, the first number may be approximately 11 and the second number may be approximately 13. In various implementations, the ratio of asperities may be controlled as a function of component particle or grain size, groove size, or relative angular orientation of the surfaces.

These and other features of the present invention are described in greater detail below in the section titled Detailed Description of the Invention.

### BRIEF DESCRIPTION OF THE DRAWING FIGURES

The present invention is described herein with reference to the following drawing figures:

FIG. 1 is a cross-sectional elevation view of first and second surfaces arranged or designed in accordance with the present invention to minimize interaction;

FIG. 2 is a plan view of a first surface under a second surface, wherein the surfaces are oriented at 0 degrees relative to one another; and

FIG. 3 is a plan view of the first surface under the second surface of FIG. 3, wherein the surfaces are oriented angularly relative to one another; and

FIG. 4 is a cross-sectional elevation view of first and second surfaces arranged or designed in accordance with the present invention to maximize interaction.

### DETAILED DESCRIPTION OF THE INVENTION

With reference to the drawing figures, a system and method are herein described, shown, and otherwise disclosed in accordance with various embodiments, including a preferred embodiment, of the present invention.

More specifically, the present invention provides a system and method for controlling interaction, i.e., interpenetration, between surfaces, and thereby controlling friction, heat, and abrasive wear between the surfaces. The system and method are scale independent, and, as such, have potential applications at, e.g., atomic, molecular, nanomachine, conventional mechanical, and geologic scales. For example, potential applications include minimizing friction, heat, and abrasive wear in unlubricated bearings and in lubricated bearings where the lubricant fails to fully and continuously support the load.

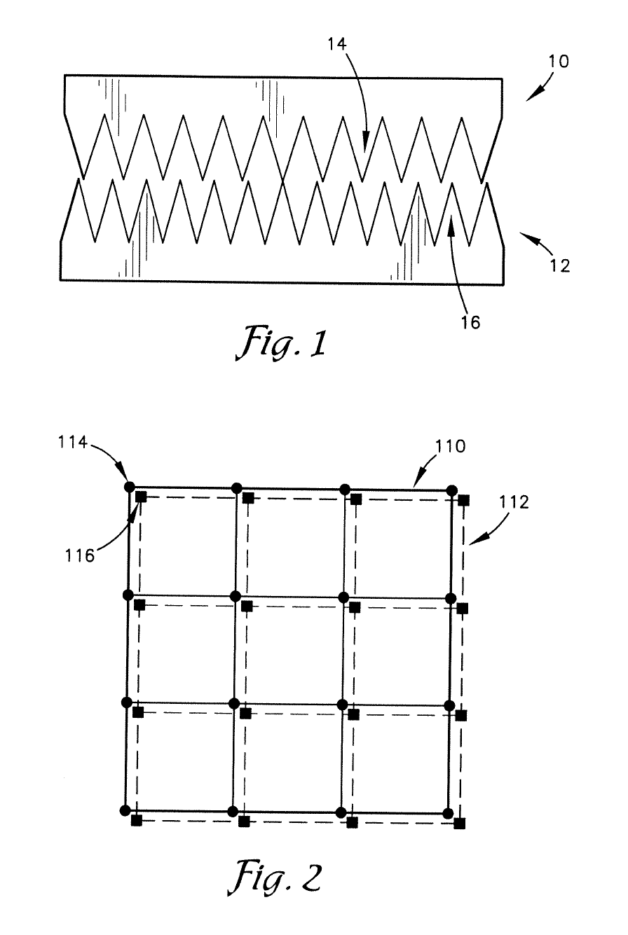

Broadly, referring to FIG. 1, when it is desired to reduce interaction between first and second surfaces 10,12, the surfaces 10,12 are arranged or designed such that the repetitive surface geometries 14,16, or “asperities”, of the surfaces 10,12 are in relative prime ratio. More specifically, the number of asperities 14 of the first surface 10 per unit length of surface is a first number, and the number of asperities 16 of the second surface 12 per unit length of surface is a second number, wherein the first and second numbers are in relative prime ratio.

“Relative prime ratio” means that the first and second numbers share no common divisors other than 1. Thus, for example, the first and second numbers may both be prime numbers, such as 7:11 or 17:19, or one of the numbers may be prime and the other number may be any number which has no common divisors with the first number (other than 1), such as 8:11 or 16:19, or neither of the numbers may be prime so long as there are no common divisors between them (other than 1), such as 9:10 or 15:16.

For certain applications, a relative prime ratio of 11:13 may provide 30 maximum support with minimum interpenetration. In this example, unit length of surface corresponds to the distance between the 1st and 11th asperities of the first surface 10 (which is equivalent to the distance between the 1st and 13th asperities of the second surface 12). As such, there is only one point of contact, i.e., one point at which an asperity 14 of the first surface 10 aligns with and contacts an asperity 16 of the second surface 12, over the unit length of surface. Additionally, the 5th and 6th asperities provide intermediate support during the transition between contacting asperities when the surfaces 10,14 are moving relative to one another.

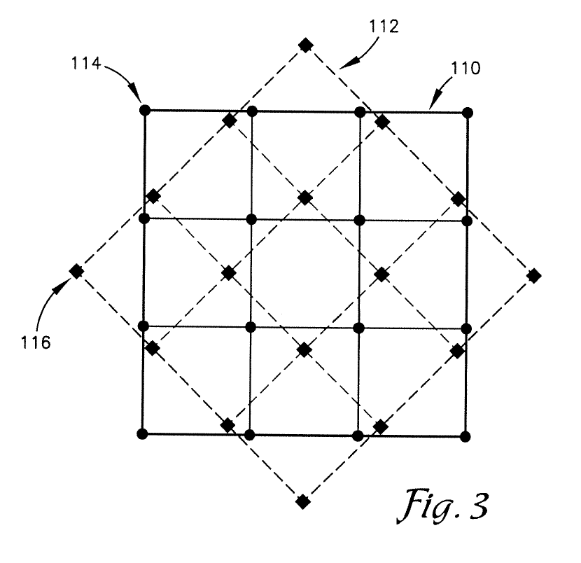

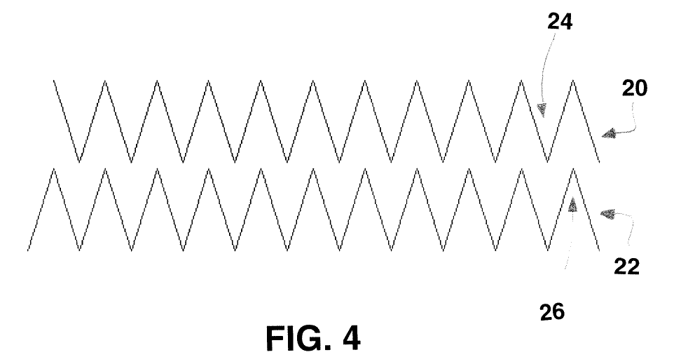

Referring to FIGS. 2 and 3, another way of changing the asperity ration between the first and second surfaces 110,112 is to change the angle of one surface relative to the other. More specifically, in FIG. 3 the first surface 110 is shown under the second surface 112, and the surfaces 110,112 are oriented at 0 degrees relative to one another. In this orientation, the asperities 114,116 are in a first ratio, e.g., 1:1. In FIG. 4, the surfaces 110,112 are oriented angularly to one another. In this orientation, the asperities 114,116 are in a second ratio, e.g., 2:3, which results in less interaction than the first ratio.

Referring to FIG. 4, when it is desired to increase interaction between first and second surfaces 20,22, the surfaces 20,22 are arranged or designed such that the repetitive asperities 24,26 are in integer divisible ratios. More specifically, the number of asperities 24 of the first surface 20 per unit length of surface is a first number, and the number of asperities 26 of the second surface 22 per unit length of surface is a second number, wherein the second number is an integer multiple of the first number.

For certain scales or materials, e.g., ceramics and metals, these relative asperity ratios can be controlled as a function of component particle or grain size, while 10 for other scales or materials, e.g., machined materials, these ratios can be controlled as a function of groove size.

Potential applications for the present invention include reducing friction in or between piston rings and cylinder walls; gears; linear and non-linear bearings and journals; telescoping mechanisms; scroll compressors; engines; and pumps. Furthermore, the present invention may be used in both unlubricated and lubricated applications.

For some applications it may be desirable to increase or decrease interaction at one scale, and do the opposite at another scale. For example, it may be desirable to decrease interaction at a relatively large scale between a piston ring and a cylinder wall so as to minimize large scale friction, and increase interaction at a relatively small scale so as to more quickly accomplish seating the ring. Thus, on a relatively large scale, the ring and wall surfaces would appear substantially as shown in FIG. 1, while on a relatively small scale, i.e., the tip of each large scale asperity, the ring and wall surfaces would appear substantially as shown in FIG. 4. Similarly, it may be desirable to increase interaction at a relatively large scale and decrease interaction at a relatively small scale.

In some applications, at least one of the materials presenting the first and second surfaces 10,12 may be non-solid. For example, in some applications, the first surface 10 may be a solid, and the second surface 12 may comprise molecules of a liquid or gas such that they behave substantially as a solid surface adjacent to the first surface 10. In one such application, the first surface 10 may be a chute, and the second surface 12 may comprise grains of sand flowing down the chute. In another of such applications, the first surface 10 may be a pipe, and the second surface 12 may comprise a liquid or gas under pressure flowing through the pipe.

Although the present invention has been disclosed with reference to particular embodiments, implementations, versions, and features it is understood that equivalents may be employed and substitutions made herein without departing from the contemplated scope of protection.

Having thus described the preferred embodiment of the invention, what is claimed as new and desired to be protected by Letters Patent includes the following:

1-38. (canceled)

39. A system comprising:
a first surface having a first number of repetitive surface asperities per unit length of surface; and
a second surface having a second number of repetitive surface asperities per unit length of surface, and
wherein the first and second surfaces move relative to each other.

40. The system as set forth in claim 39, wherein the first number is approximately 11 and the second number is approximately 13.

41. The system as set forth in claim 39, further wherein the first and second numbers are in relative prime ratio.

42. The system as set forth in claim 39, further wherein the first and second numbers have no common divisors other than 1.

43. The system as set forth in claim 39, further wherein the second number is an integer multiple of the first number.

44. A method of controlling interaction between first and second surfaces, the method comprising the steps of:
providing the first surface with a first number of repetitive surface asperities per unit length of surface; and
providing the second surface with a second number of repetitive surface asperities per unit length of surface.

45. The method as set forth in claim 44, wherein the first number is approximately 11 and the second number is approximately 13.

46. The method as set forth in claim 44, further wherein the first and second numbers are in relative prime ratio, and the interaction between the first and second surfaces is reduced.

47. The method as set forth in claim 44, further wherein the first and second numbers have no common divisors other than 1, and the interaction between the first and second surfaces is reduced.

48. The method as set forth in claim 44, further wherein the second number is an integer multiple of the first number, and the interaction between the first and second surfaces is increased.

49. The method as set forth in claim 44, wherein the number of repetitive surface asperities is controlled as a function of component particle or grain size.

50. The method as set forth in claim 44, wherein the number of repetitive surface asperities is controlled as a function of groove size.

51. The method as set forth in claim 44, wherein the ratio of the first number to the second number is controlled as a function of the angular orientation of the first surface relative to the second surface.

52. A system comprising:
at a first scale
a first surface having a first number of repetitive surface asperities per unit length of surface, and
a second surface having a second number of repetitive surface asperities per unit length of surface; and
at a second scale
a third surface having a third number of repetitive surface asperities per unit length of surface, and
a fourth surface having a fourth number of repetitive surface asperities per unit length of surface,
wherein the third number is an integer multiple of the fourth number.

53. The system as set forth in claim 52, wherein the first scale is larger than the second scale.

54. The system as set forth in claim 52, wherein the first scale is smaller than the second scale.

55. The system as set forth in claim 52, further wherein the first and second numbers have no common divisor other than 1.

56. The system as set forth in claim 52, further wherein the first and second numbers are in relative prime ratio.

57. A method of controlling interaction between surfaces, the method comprising the steps of:
at a first scale, reducing interaction by
providing a first surface with a first number of repetitive surface asperities per unit length of surface, and
providing a second surface with a second number of repetitive surface asperities per unit length of surface; and
at a second scale, increasing interaction by
providing a third surface with a third number of repetitive surface asperities per unit length of surface, and
providing a fourth surface with a fourth number of repetitive surface asperities per unit length of surface,
wherein the third number is an integer multiple of the fourth number.

58. The method as set forth in claim 57, where in the first scale is larger than the second scale.

59. The method as set forth in claim 57, wherein the first scale is smaller than the second scale.

60. The method as set forth in claim 57, further wherein the first and second numbers are in relative prime ratio.

61. The method as set forth in claim 57, further wherein the first and second numbers have no common divisor other than 1.
